(19) United States
(12) Patent Application Publication
(10) Pub. No.: US 2004/0138931 A1
(43) Pub. Date: Jul. 15, 2004

(54) Trend detection in an event management system

(76) Inventors: Clifford C. Hope, Anerley (GB); Christopher C. Massey, Hanwell (GB); Richard Turner, Kingston Upon Thames (GB)

Correspondence Address: SHUMAKER & SIEFFERT, P. A., 8425 SEASONS PARKWAY, SUITE 105, ST. PAUL, MN, 55125, US

(21) Appl. No.: 10/342,440

(22) Filed: Jan. 14, 2003

(51) Int. Cl. G06F 17/60

(52) U.S. Cl. 705/7

(57) ABSTRACT

A trend detection method and system, for use in an event management system is disclosed. The method includes the steps of storing event data from a plurality of events in an event store, subsequently analyzing said stored event data, and determining one or more trends from said analysis.

### FIELD OF THE INVENTION

The present invention relates generally to corporate performance management (CPM) systems, and more particularly to event management techniques and applications.

### BACKGROUND OF THE INVENTION

Broadly stated, an event management system (EMS) enables internal and external data from multiple disparate applications to be related and evaluated, making traditional data sources “event aware”. Event management initiates appropriate actions upon detection of an event to ensure successful resolution of that event. An event is defined as an occurrence of one or more pre-defined business rules evaluating to true, business rules providing user-defined data thresholds.

Every business has predictable events that create opportunities and risks. Some of these events are time-critical, requiring timely attention to prevent a lost opportunity. The greatest potential for maximizing opportunities or minimizing risks associated with time-critical business events exists immediately after the event occurs. Adding notifications to the reporting environment helps to effectively manage time-critical events by notifying one or more individuals when the event occurs.

In addition, notifications enhance existing reporting methods by reducing the time and effort required to track key performance indicators or other information. After receiving a notification, the recipient can use other reporting tools to obtain additional information before initiating a corrective action or process.

The problem is that there are many events affecting a business that are too dynamic to be modeled in any single operational system. For example, a stock-control system can be designed to place replenishment orders automatically when stocks are low, and when new stock is received to allocate it to outstanding customer orders according to one or more predetermined rules, such as oldest orders first or largest orders first.

What the stock-control system will not be designed to take into account is that a particular customer has, over the last three months, received two faulty items, an incorrect final payment demand, and an inappropriate remark from the switchboard operator, and if there's one more problem they'll take their business elsewhere. Therefore, receipt of an order from that customer that cannot be fulfilled because an item is currently out of stock is an event that the account manager needs to know about immediately in order to effectively manage the relationship with that customer. In this case, the business event that requires management is derived from multiple indicators spanning several systems.

In addition, there are many events over which we have no direct control but which have a direct impact on our sphere of responsibility. For example, movements in commodity prices or exchange rates can invalidate existing plans and forecasts. It would be advantageous for these external factors to be monitored so that forecasts can be revised if original assumptions are no longer valid. Event management endeavors to assist in moving an issue forward to a sensible next step and conclusion, or “managing the event”.

It could be argued that all business intelligence (BI) application software performs some form of event management. Analysts model the anticipated events that will occur within the system, including anticipated exceptions, and apply a process for handling them. The system then deals with routine events and exceptions and produces reports on those it is not designed to handle.

BI applications are often used as rudimentary forms of event detection. Reports enable users to receive regular indications of business performance. Typically, the data on which they are reporting is derived from multiple sources and is loaded into a data warehouse and data marts by an extraction, transformation, and loading (ETL) tool. This data can often form the bedrock on which a company's strategies are based and subsequently monitored.

However, these traditional BI tools are not well suited to providing feedback on rapidly changing business conditions. Traditional reporting is fixed, not focused on the user. Furthermore, it is difficult to incorporate external data that may change frequently into data marts or other data stores. The onus is still on the user to locate the data that directly affects them. The sheer volume of data available can result in more time, not less, being spent identifying important items that require action.

Early event management solutions included systems such as financial trading systems that created alarms, alerts, or warnings when stocks and commodities crossed a pre-determined threshold to alert the trader to take appropriate action.

In supply chain solutions there are mechanisms by which appropriate people can be warned if, given the demand forecast and current inventory holding, unless stock is moved from warehouse A to warehouse B now, the forecasted demand at a given retail outlet won't be met because of the time taken to ship inventory.

The problem is that these early event management systems have at least two problems in common. Firstly, they tend to be restricted to a single system and cover only a single process. Secondly, they are built into the application, and therefore are not a platform. The implication being that if you want that capability in another system, it has to be painstakingly rewritten for that system.

Modern EMS's now typically include business activity monitoring (BAM) capability. At its broadest level, BAM is the convergence of traditional business intelligence (BI) and real-time application integration. Information is drawn from multiple application systems and other sources, both internal and external, to provide a richer view of business activities and the potential to improve business decisions through availability of the latest information. BAM aims to reduce the time between information being captured in one place and being usable in another.

Knowing that several similar complaints have occurred is also important. One can analyze the source reasons for these complaints and take more tactical and strategic actions to control these issues and prevent such complaints from arising in the first place. This is where traditional BI meets modern BAM EMS capabilities, coming full circle whereby the aggregation of events enhances tactical and strategic decision-making. Therefore, a modern EMS system preferably includes both BAM and more traditional BI as part of a total solution.

In a modern EMS there are generally three types of events to monitor and detect: Notification events, which involve monitoring the availability of new report content. Performance events, which involve monitoring changes to performance measures held in data sources. Thirdly are operational events, which involve looking for events that occur in operational data, BAM territory.

In a typical scenario, software agents evaluate events as they occur according to a set of rules that determine what action should be taken. Once data has been processed, information is made available to people or other processes. Information to people is typically provided in the form of alerts, data summaries, and metrics.

What is needed is a system that can run agents more often in the background on the user's behalf to bring critical information to the attention of users, rather than relying on them to find it. Such a system should free users from the routine scanning of reports, creating time for them to investigate new areas. It should also improve efficiency by running reports by necessity, rather than by schedule.

As well, any proposed system should be capable of automating the detection of critical business events, and by bringing together relevant information from multiple sources, and disseminate information to individual recipients or other business systems. Further, it should monitor an event to ensure successful resolution and generate new BI information. By automatically monitoring events in real-time or on a schedule, an EMS can enable users to keep track of a greater number of events, and with a finer degree of granularity.

Further, since an event typically represents an important situation, the EMS should be capable of “pushing” data about the event to a delivery system in a timely manner. It should be possible for users to view data from different angles to discover or understand trends and inconsistencies. It would also be advantageous to provide “drill down” capability to reveal more detail in an effort to unearth the causes, and then if such an analysis is useful, new reports can be commissioned so that the information can he reviewed on a regular basis.

Any proposed system should be capable of reducing the time between information capture and use, and provide personalized delivery to suit the work patterns of the recipient. In addition, such a system should reduce or eliminate duplicate or irrelevant message deliveries to ensure message content is always of the highest value, and provide support for desktop and mobile devices through electronic mail.

Furthermore, if an event definition requires the use of more than one source of data, the EMS should be capable of “joining” those sources. It would also be advantageous to insert rule values at time of execution, and detect events occurring in ‘real-time’ or ‘transient’ data sources. As well, since event detection may require the monitoring of data external to the organization, support should be provided via external services.

For the foregoing reasons, there is a need for an improved method and system for event management.

### SUMMARY OF THE INVENTION

The present invention is directed to a trend detection method and system for use in an event management system. The method includes the steps of storing event data from a plurality of events in an event store, subsequently analyzing said stored event data, and determining one or more trends from said analysis. In an aspect of the invention, the method further includes the step of updating said event management system based on a determined trend.

The system includes an event data store for storing event data from a plurality of events; an analyzer for subsequently analyzing said stored event data, and a trend determiner for determining one or more trends from said analysis.

The invention can monitor operational events across multiple processes since the architecture enables the “joining together” of disparate systems, and can provide support for managers with responsibilities that cross several processes. The invention enables agents to be defined in a manner that enables them to cross multiple systems.

The system minimizes the amount and increases the quality of events detected. As well, the system is processor efficient, avoiding “brute force” methods that require large overhead. The invention filters events to see only useful information, empowering users by maximizing the opportunities and minimizing the risks.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

These and other features, aspects, and advantages of the present invention will become better understood with regard to the following description, appended claims, and accompanying drawings where:

FIG. 1 illustrates an event management system in accordance with an embodiment of the present invention;

FIG. 2 illustrates the event management system architecture in accordance with an embodiment of the present invention;

FIG. 3 illustrates the logical data flow of an agent; and

FIGS. 4-22 illustrate embodiments of the present invention.

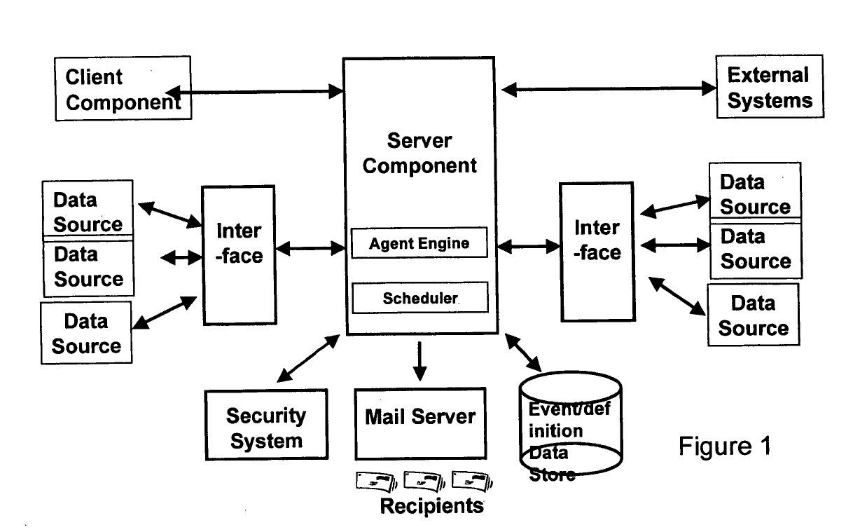

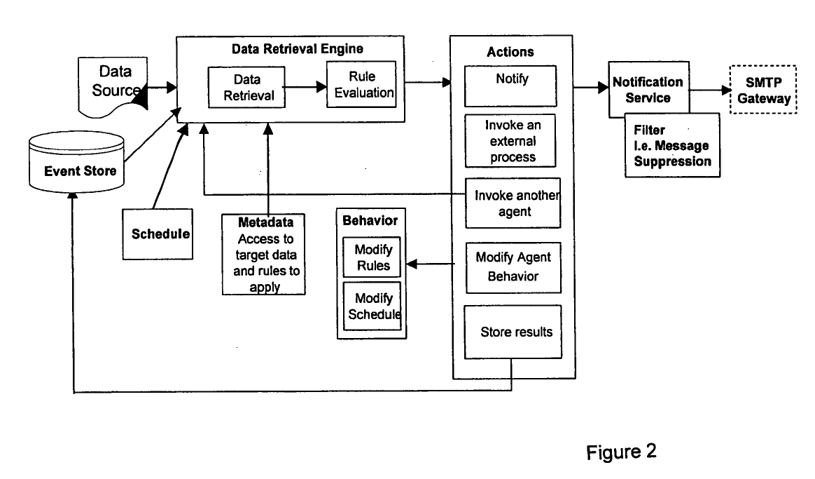

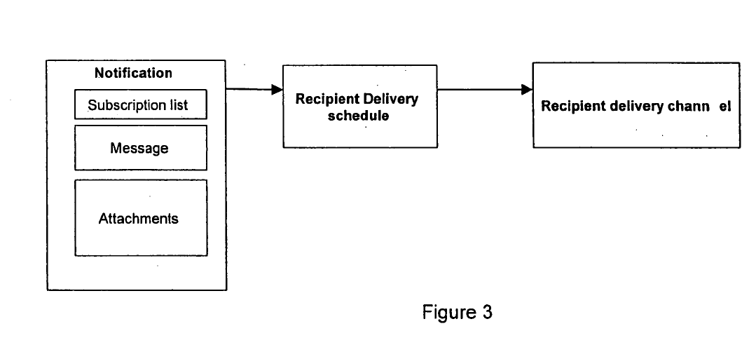

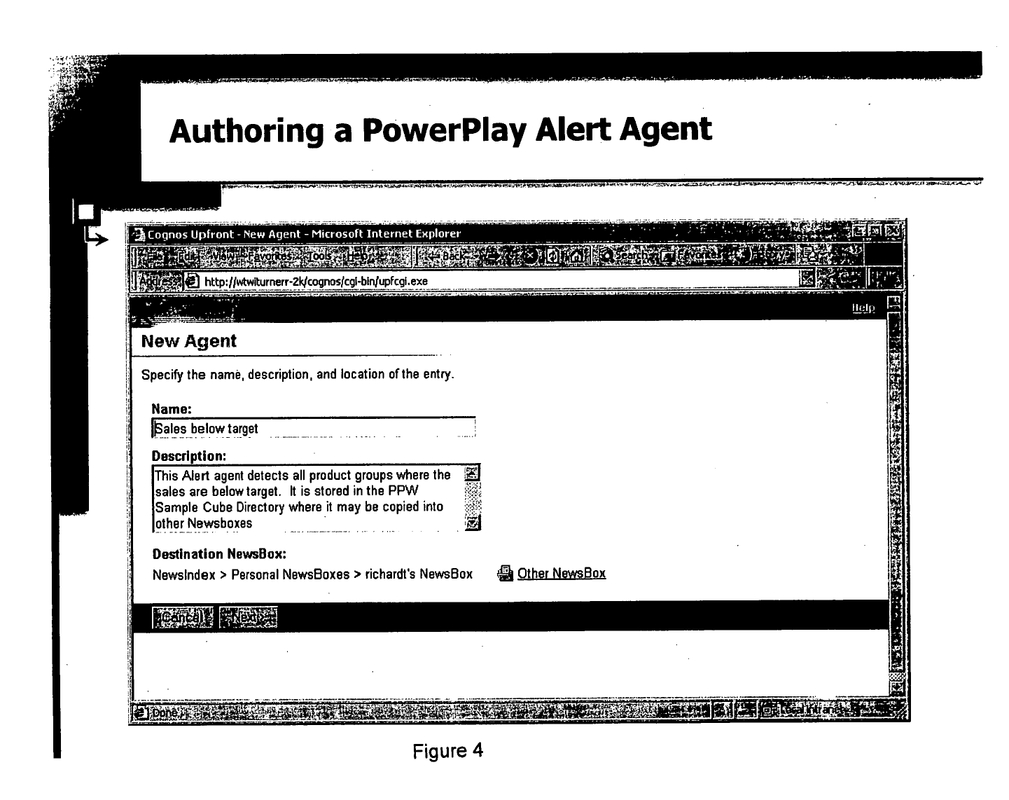

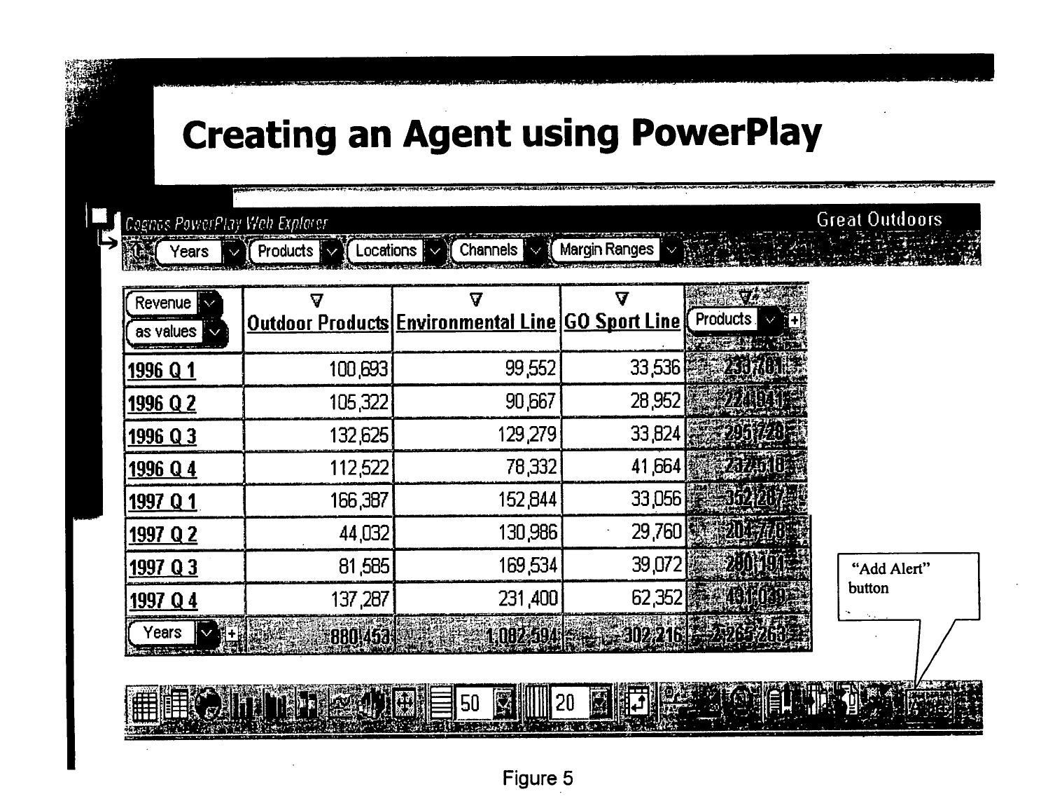

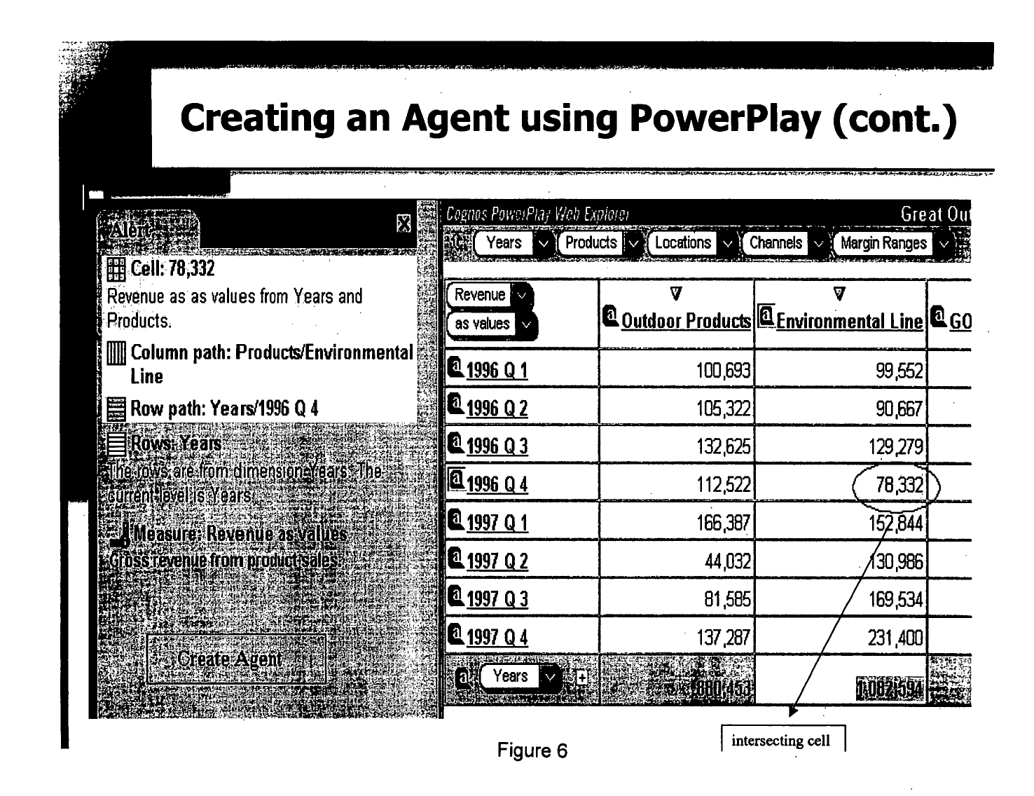

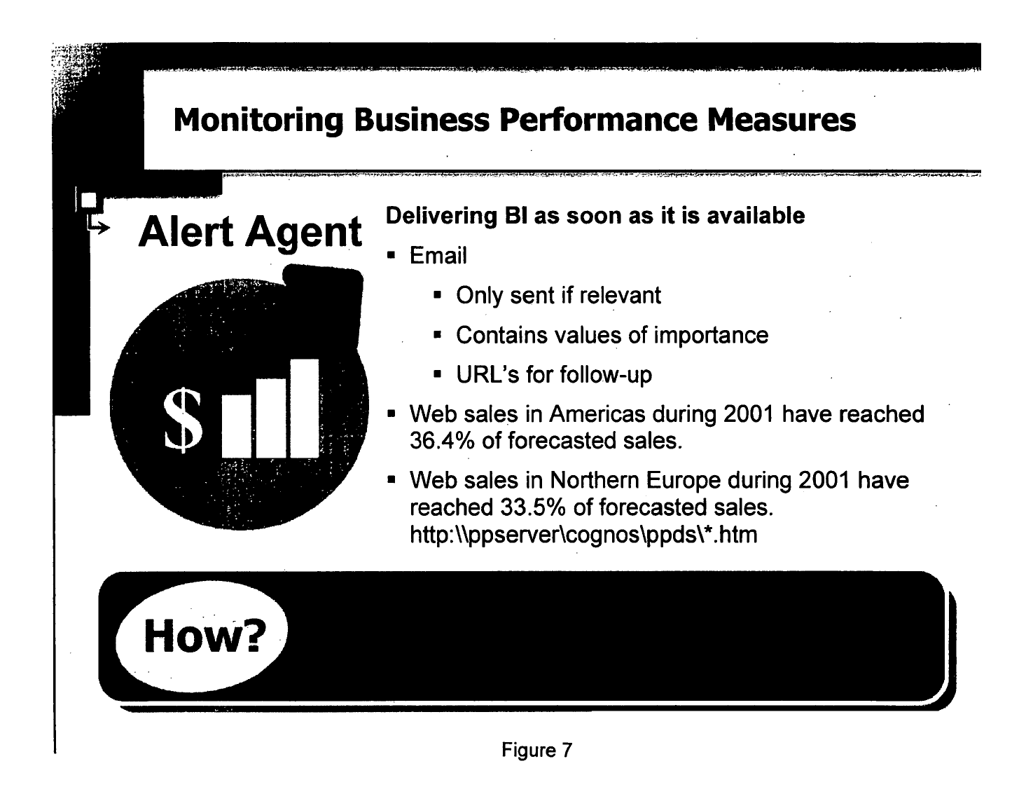

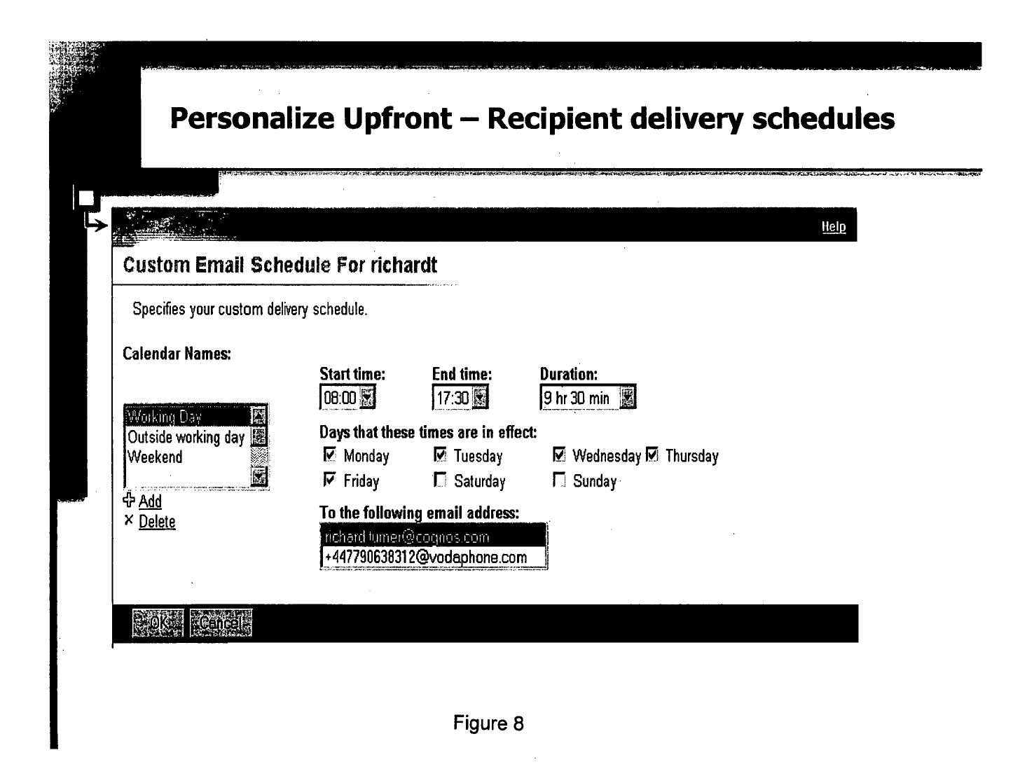

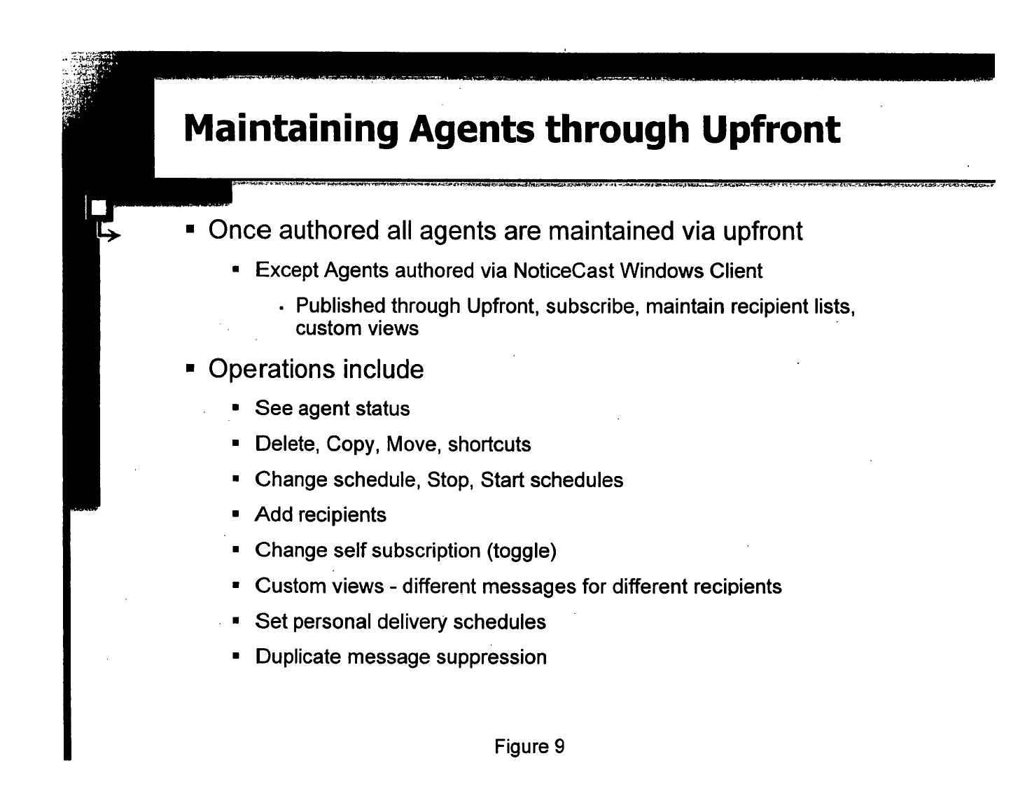

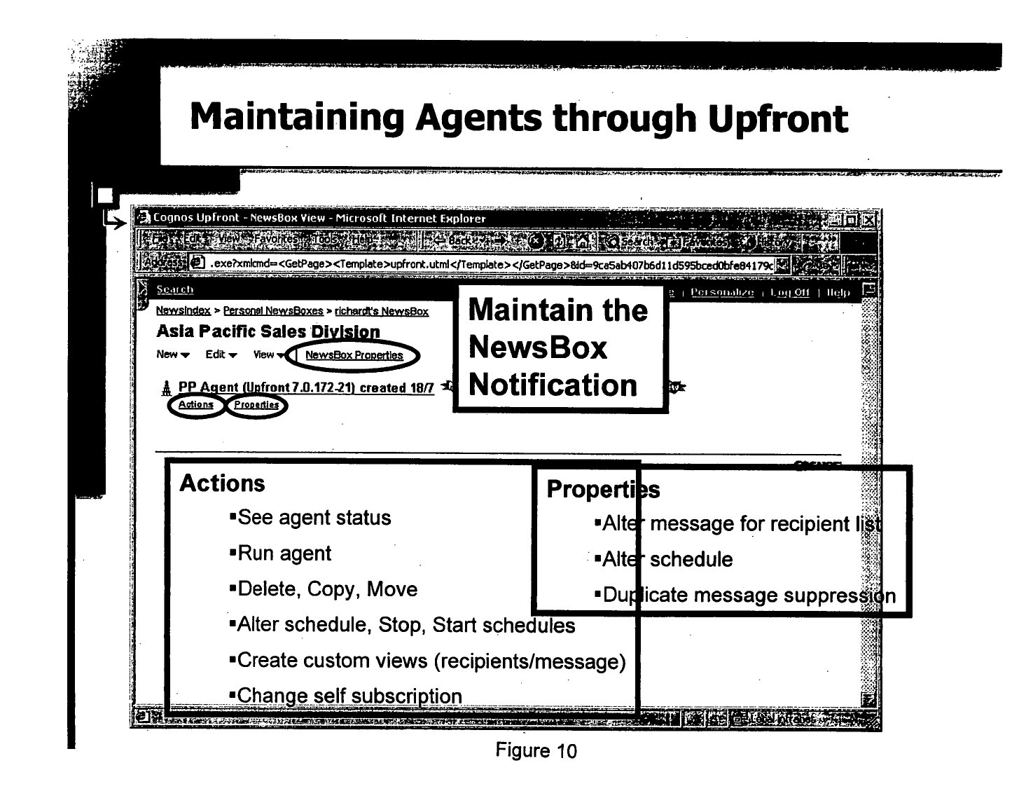

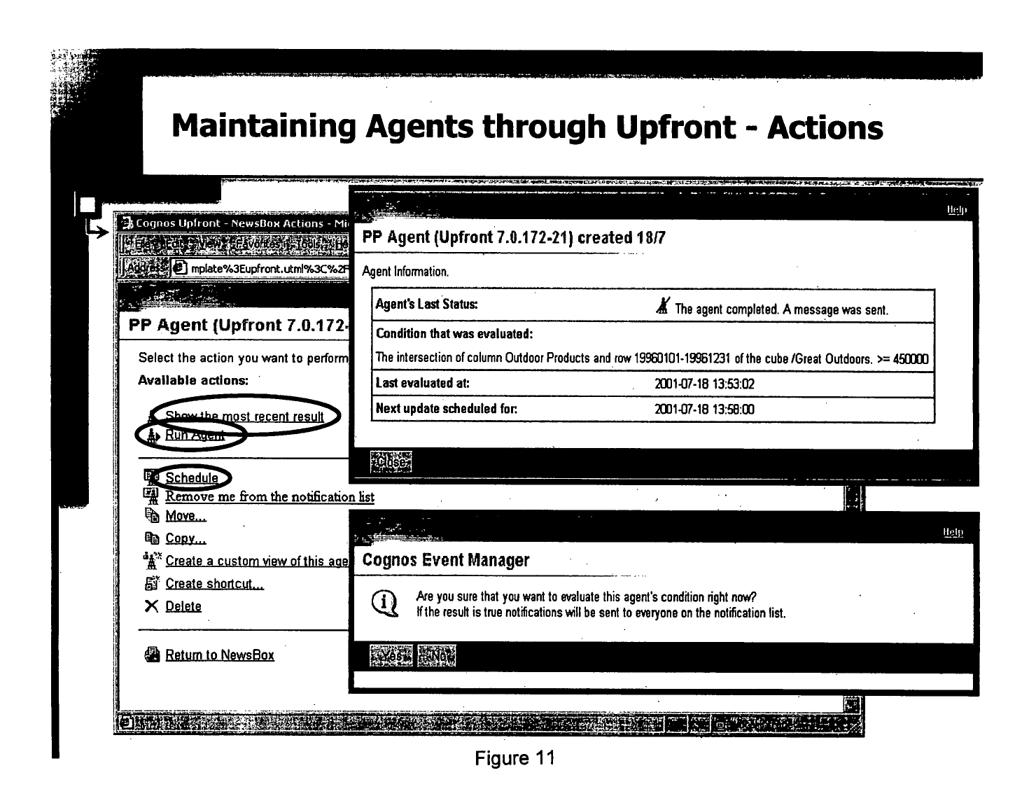

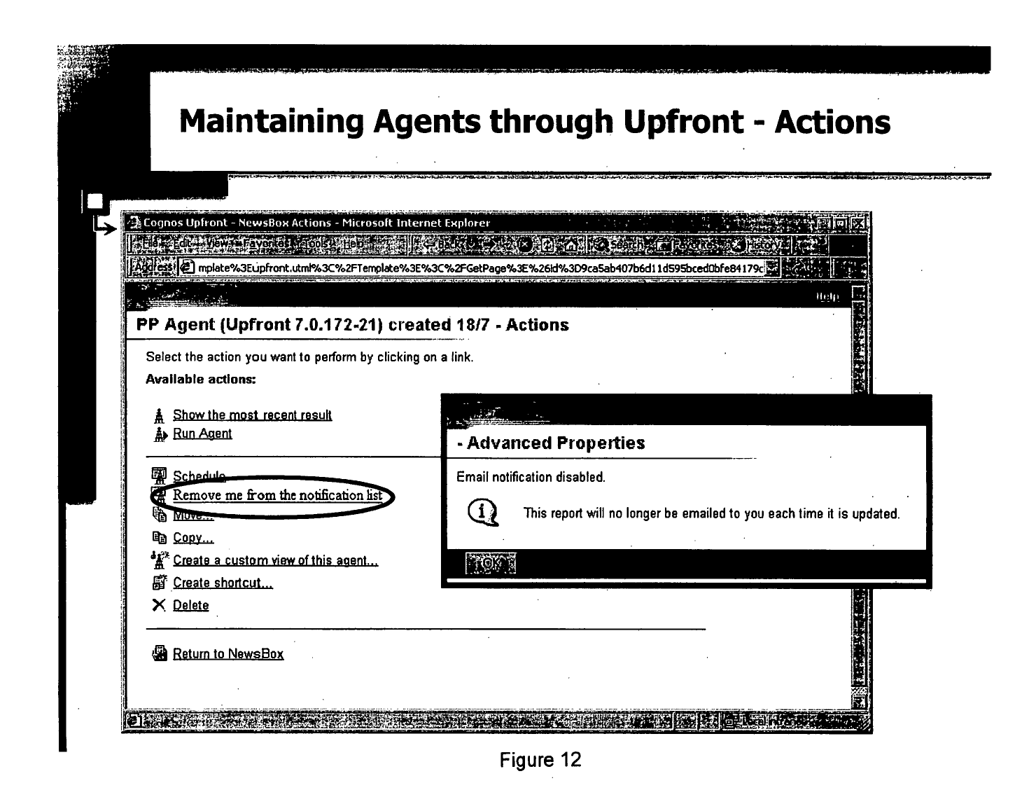

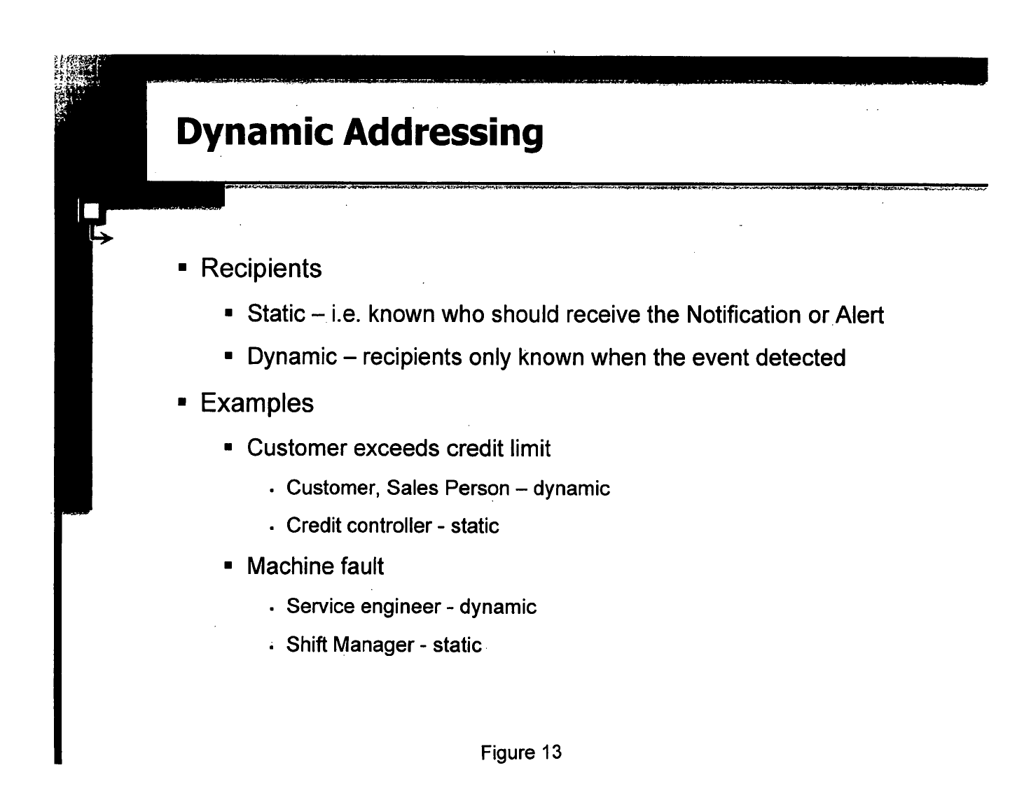

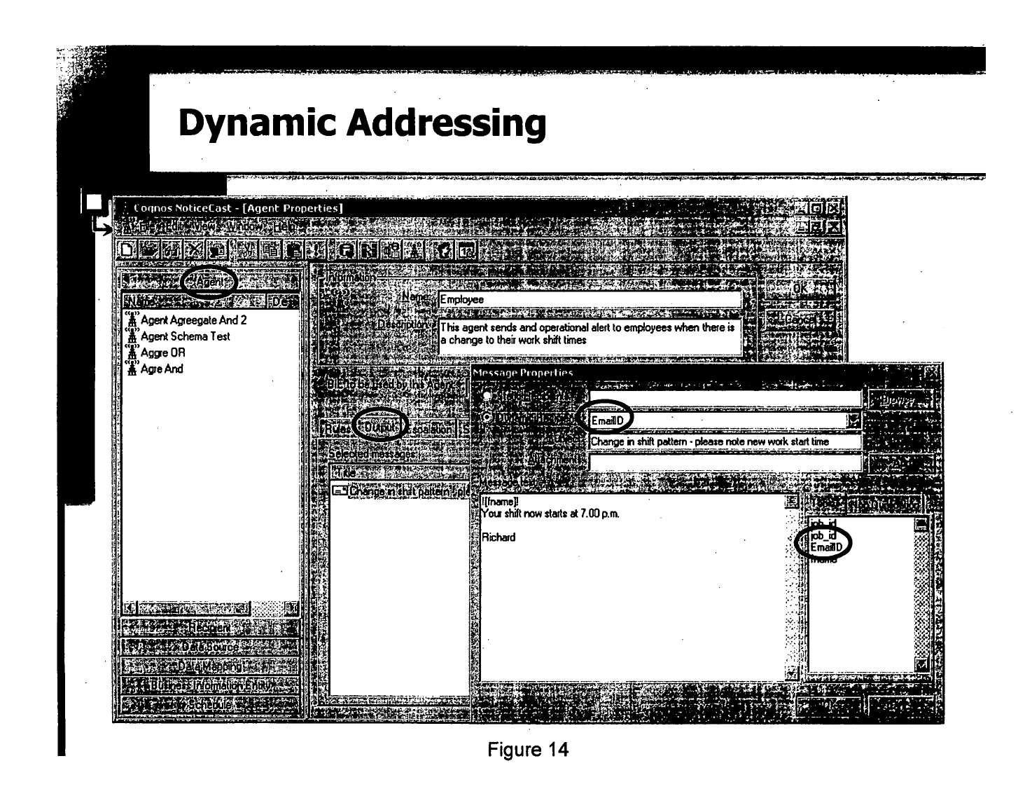

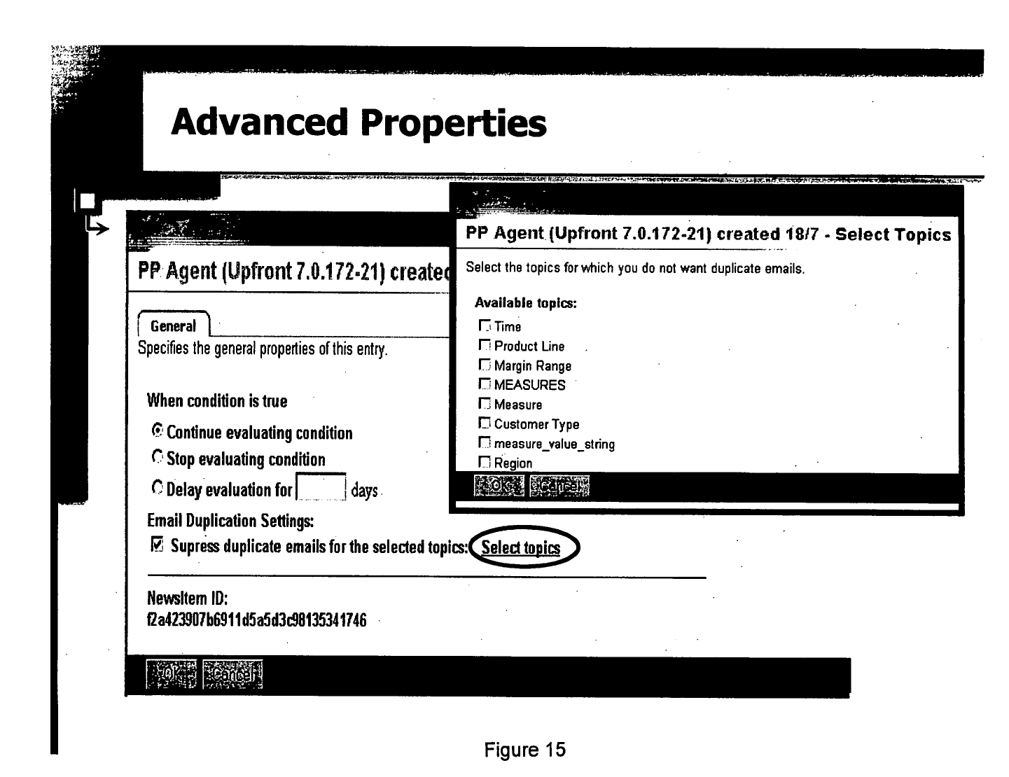

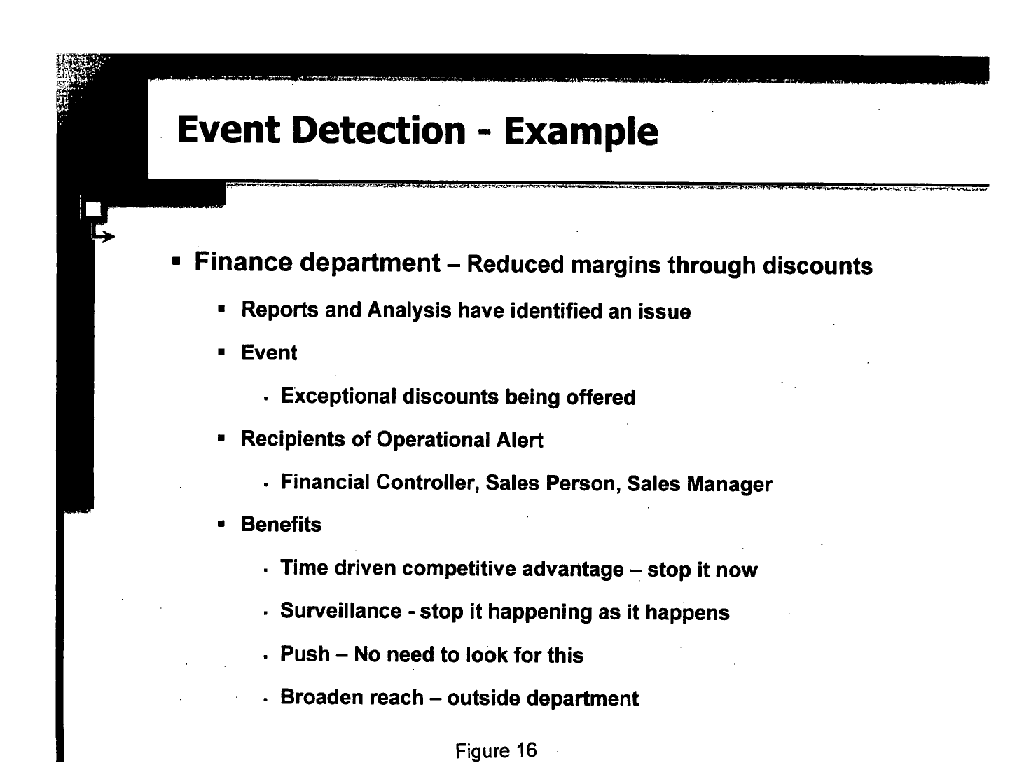

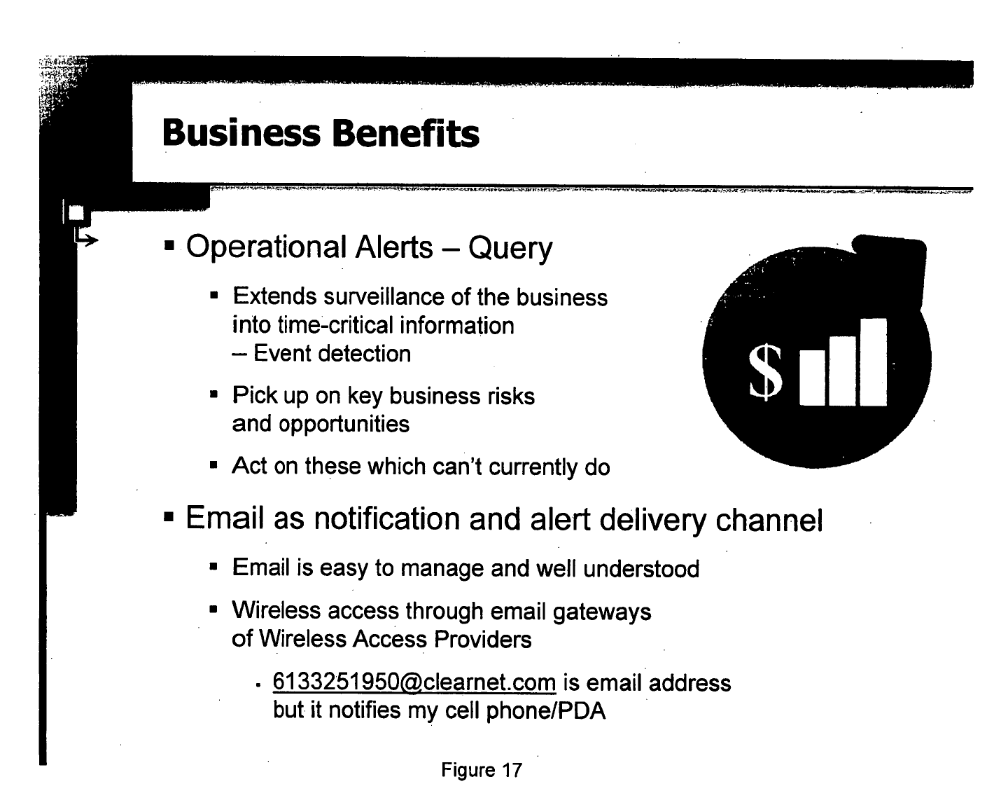

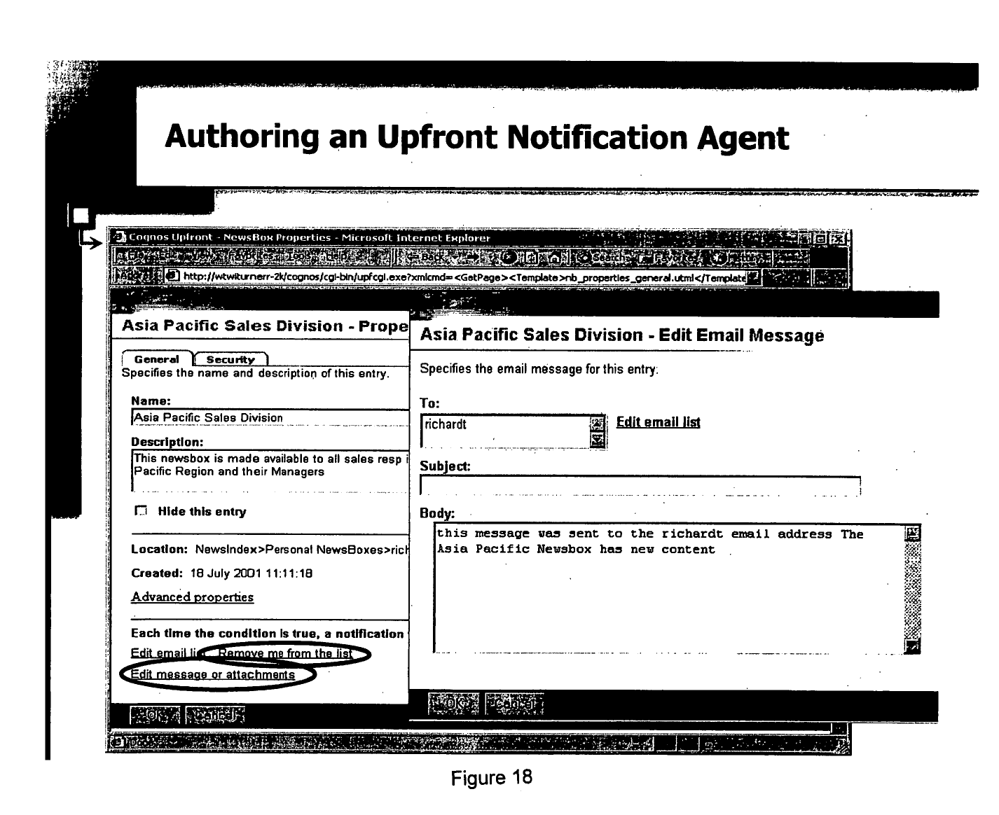

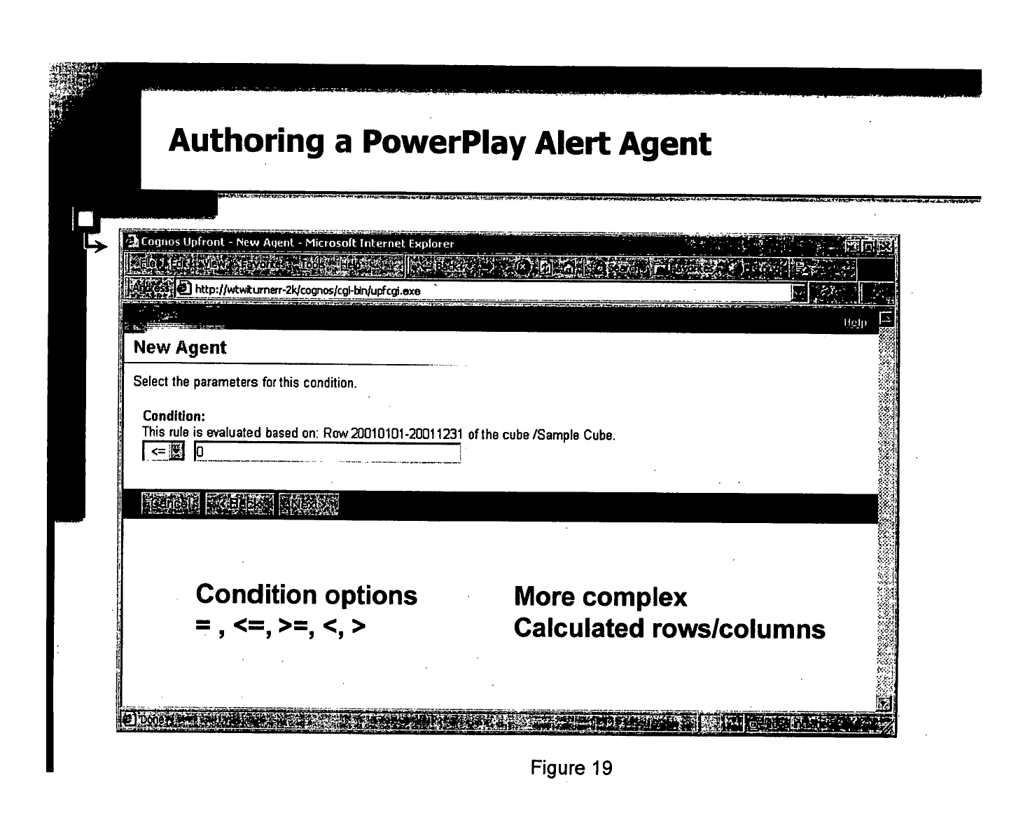

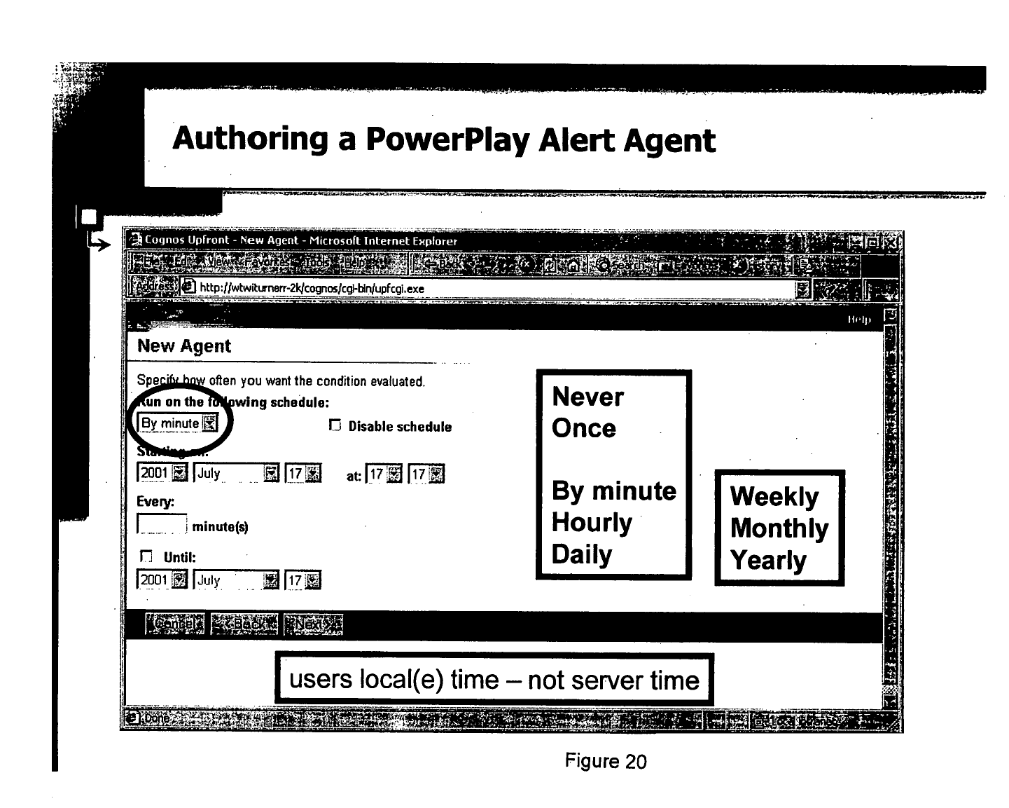

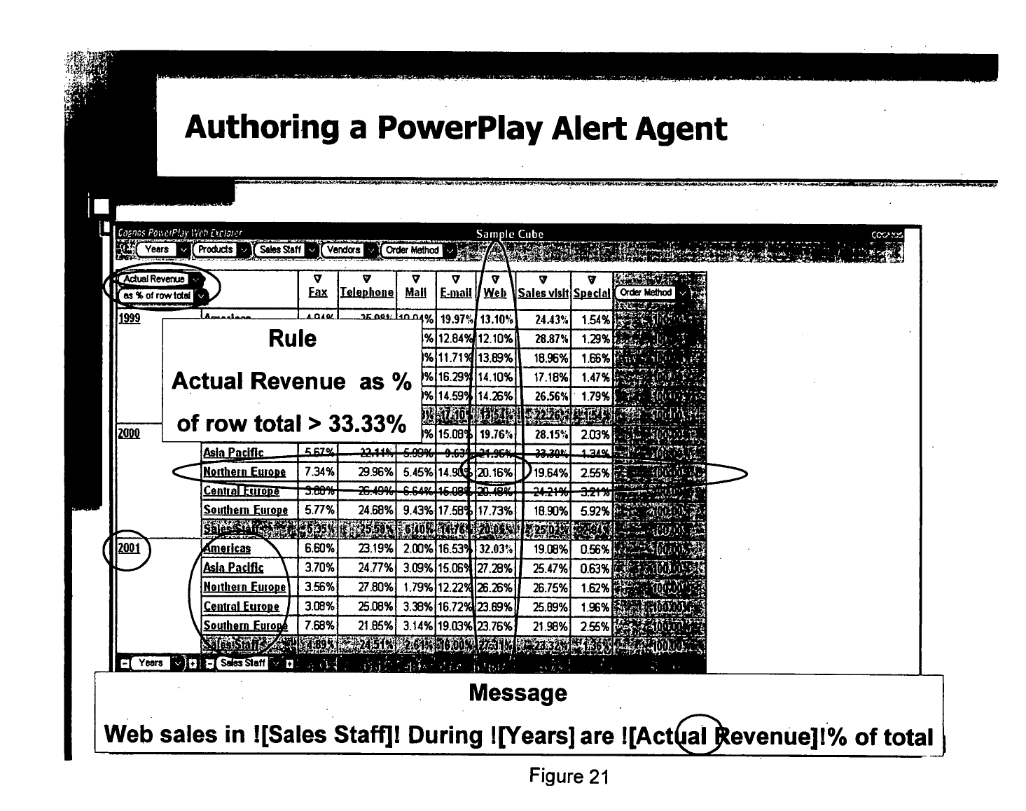

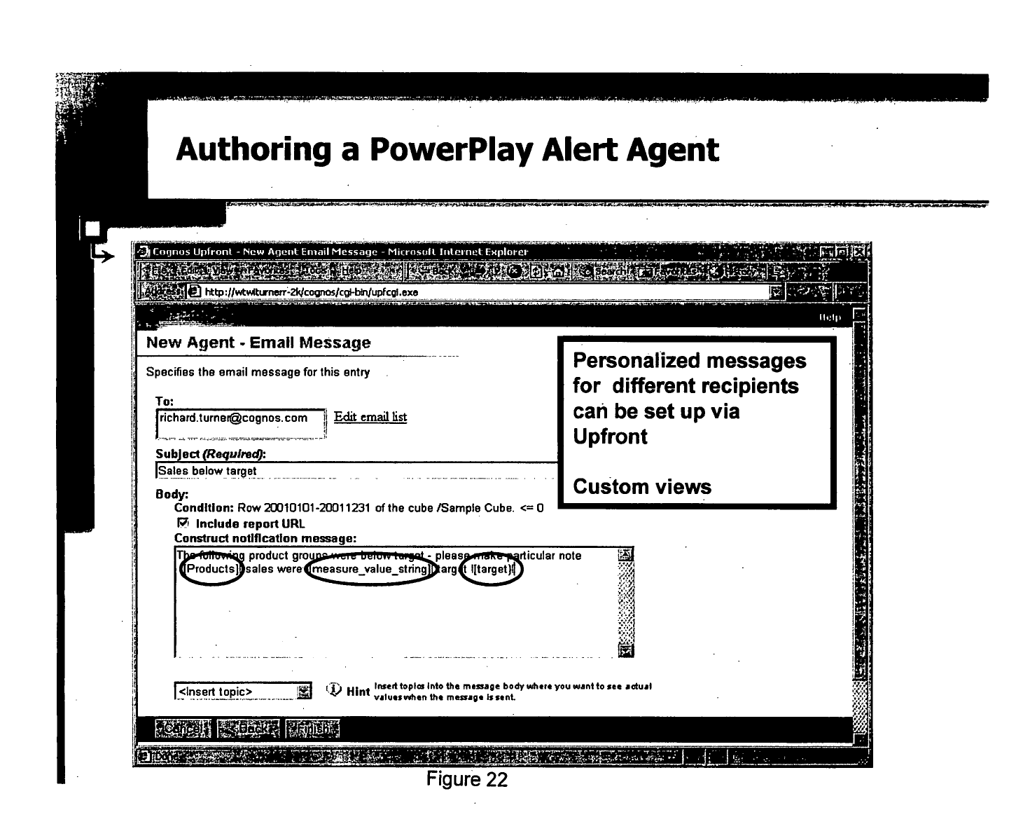

### DETAILED DESCRIPTION OF THE PRESENTLY PREFERRED EMBODIMENT

The present invention is directed to a trend detection method and system for use in an event management system. The method includes the steps of storing event data from a plurality of events in an event store 102, subsequently analyzing said stored event data 104, and determining one or more trends from said analysis 106.

In an embodiment of the present invention, the method further includes the step of updating said event management system based on a determined trend 108.

The system includes an event data store 12 for storing event data 14 from a plurality of events; an analyzer 16 for subsequently analyzing said stored event data 14, and a trend determiner 18 for determining one or more trends from said analysis.

In an embodiment of the present invention, the event management system has access to at least one data source and includes a server component, a definition data store for storing data definitions; a client component for authoring said agents using said definitions; and an interface between said agent engine and said data source. The server component includes an agent engine for creating one or more agents, and a scheduler for running said created agents.

The system is capable of passing event data from one process to another for further analysis. The result of the event evaluation and the data values encountered are saved as a source of further analytical data. The resulting store can then be used to provide information concerning the frequency of events or to predict future outcomes. By recording the outcome of each agent execution in an “event result store” new information becomes available.

Analyzing this data to identify frequency indicators, in contrast to dealing with individual occurrences of an event, can show the frequency of occurrences of events over time. This can help identify systematic failures of business processes. For example, having insufficient stock to meet current orders is an event that may need to be communicated to a sales manager and a purchasing clerk. But repeated occurrences of this situation may need to be communicated to the purchasing manager since it may indicate incorrect purchasing policy or a failing relationship with the supplier.

The system is capable of initiating predictors, or early indications that action should be taken to exploit an opportunity or, at least as important, to avoid a crisis. By periodically recording actual event values, over time a history of information can be obtained. By applying predictive modeling techniques, this timeline can be extended into the future and ultimately used to predict critical events before they happen.

When an agent runs, it has a number of data values to evaluate. An evaluation indication shows the existence of an event. In either case; YES or NO can be written to a data store to provide a history. This history becomes another source for evaluation for use in such tasks as forecasting through extrapolation, making it possible to predict events in the future, frequencies of particular events, metadata, and/or occurrences of failures used for different elements of decisions.

The server component handles all communications between the data store and the authoring tools, and includes the scheduling service that runs the agents. As well it retrieves and evaluates information from one or more data sources when an agent determines that a business event occurred.

The scheduler and agent engine are both located within the server component. An agent is a task that is run according to a schedule. It evaluates data items, defined by business information entity (BIE) topics retrieved from external data sources according to a set of rules. If the application of rules returns a result set, then the agent will typically construct a message and send it to appropriate recipients. An agent can also invoke another agent.

Agent authors use the client GUI to create agents that monitor data sources to detect the occurrence of a business event. When an agent detects a business event, the agent sends notifications in the form of email messages to one or more recipients.

The data source is any system that is be interrogated to detect an event. Data sources can include financial, sales, CRM, ERP, or any other operational system within the organization used to manage operational processes. Some of these real time data sources may well reside outside the organization, such as financial information, weather information, and business partners' systems.

The client module: Business Information Entity (BIE) is built on data mapping, which in turn is built on a data source definition. All assembled to create an agent that is built on BIE's with one or more rules. Variable at time of running of agent. Templating for schedules. Send email; execute applications; write back to database. Window pops up requesting entry of variable value. “Dynamic recipient” is dependent on results of a query. Agents can be re-tasked to slow down; stop; or other option/feature.

The administration tool: supports agent authors by providing access to the data store and creating a common data source pool, controls the scheduling service or scheduler, and views and maintains log files that contain information related to each agent.

The authoring tool: agent authors create and maintain agents using the authoring tool. The authoring tool provides access to the items in the data source pool and to other shared objects stored in the data store, such as recipient profiles and schedules. Agent authors ca set privileges to use objects based on user classes defined in Access Manager.

The scheduler provides the starting point of the process and system, and provides the trigger to make things happen. The system delivers valuable, accurate and pertinent information about time-critical business conditions to the individuals who are best able to act upon it within a time frame that ensures the information can be exploited to maximum effect.

The system uses agents to periodically collect data and evaluate it according to a number of user-defined rules. A rule determines whether or not the data has achieved “critical” status, such that it should be brought to the attention of an individual. Such a condition is called an event. If an agent detects an event, it assembles a message containing text together with the actual values of the data evaluated within the rule and any other supporting data that may be required to enable action to be taken. The message is sent to one or more recipients. A variety of message delivery systems can be supported, including e-mail, SMS mobile phone text messages, web pages, and input to other business systems via XML or other similarly flexible language.

Potentially, any form of electronic data storage could be regarded as a source that can be accessed by an agent. This includes databases, files, web pages and other computerized business systems. A means of extracting the required data from a data source is defined within a data mapping. The data mapping definition will vary according to the underlying data source. All such data is defined within a “Business Information Entity” or BIE.

Recipients of messages can have access to multiple delivery channels. Moreover, a recipient may have more than one ‘address’ within a delivery channel, such as a business and a private e-mail address. The system can determine the most appropriate delivery mechanism for a particular message. The agent is capable of selecting the current address, based upon the recipient's personal delivery schedule. An agent runs according to a schedule that defines its start and end dates/times and the frequency with which it runs within them. If an agent fails to detect an event, it will simply terminate and be reactivated at its next scheduled run time.

The system includes a central repository of objects, such as definitions of data sources, mappings, and/or recipients, held within a relational database system. The server computer is responsible for performing tasks automatically, while maintaining a connection to the repository, and storing and retrieving objects. The server machine also runs the agent scheduler, which is responsible for initiating each agent at the appropriate time, as well as the agents themselves. The server computer will repeatedly activate the business agents defined by the user at the times and frequencies assigned to each individual agent. The component responsible for activating agents is the scheduler. Finally, the server computer handles assembly and transmission of messages.

The server computer is connected to one or more client machines running user-interface components that enable users to create and edit various objects and to schedule agents. A computer process called an agent applies rules to available data to detect business events. Agents are invoke/initiated according to a schedule, or another agent, as well as certain external processes.

Upon the detection of an event, an agent constructs a message containing details about that event. Typically, this message is delivered via electronic mail to an individual capable of reacting to that event. Since a recipient may have multiple email addresses such as work and personal emails for example the agent will select which address to use based on factors such as the day or time at which an event is detected.

As well, instead of sending an email to a recipient, an agent can send a message to another business system to run another application. Agents can also invoke other agents known as escalation agents. Such agents may be tasked to check other related data sources, or simply to check that the original critical condition was resolved within a reasonable time. As well, to effectively manage an event, the system is capable of monitoring outcomes, including elements such as support for message acknowledgements to determine whether recipients have received notifications, determining whether an event still exists after an appropriate interval—during which corrective action should have taken place. If an event is still true, then an EMS should be capable of taking an alternative course of action, such as notifying a higher authority of the event or escalation.

Users schedule when an agent is to be run. The schedule is initially set within an agent wizard. It can then be subsequently changed from the agent's properties schedule page. Schedules are set according to the end user's ‘local’ time, as illustrated in the locale tab of the personalization page not the ‘server’ time, should it be situated in a different time zone. Agents typically deliver messages via SMTP email. Message recipients are selected from a drop-down list of users defined in an existing security system.

The system can conform to an existing security model to provide a common sign-on so that a user need only log-on once. Each user's access permission is controlled by their membership in a user class defined within the existing security model. Access to system objects can then be controlled in accordance with an individual's user class membership.

The system can be integrated into a spreadsheet program such that a view in a spreadsheet program will have a new “Create alert” button provided on a toolbar. A user simply selects any single cell, single row or single column and then clicks the provided “create alert” button to start an agent wizard. The wizard then prompts for a field entry such as agent name, agent description, rule such as greater then 10000, less than 1000, agent schedule, recipients, and the message format and content to be sent.

When creating a message, the measure and dimensions associated with the selected cells are listed. These measures and categories can be included as placeholders within the message body so that at runtime, the actual values of measures and categories satisfying that rule can be inserted within the body of the message.

An agent can be run automatically on data updates to improve system efficiency. This is more efficient than running to a schedule since some data sources do not change between updates. Therefore, running agents at intervals between updates is pointless in these cases since no new information is available.

As an example, in the data below a user wants to be alerted should Web sales exceed 33.33% of total sales in any area. The user first selects the Web column and creates an alert based on these elements in the following rule; “Actual Revenue as % of row total>33.33”. When creating the message, the measure and levels of actual revenue, years, and sales staff are available for inclusion. The user then creates the message, “Web sales in [Sales Staff] during [Years] have reached [Actual Revenue]% of total sales”.

But suppose that on a future data update the proportion of revenue achieved through the web during 2001 increases to 36.4% in the Americas and to 33.5% in Northern Europe, but stays <33.3% in all other areas. A message will be assembled containing the following text: “Web sales in Americas during 2001 have reached 36.4% of total sales. Web sales in Northern Europe during 2001 have reached 33.5% of total sales”.

Rules can be based on any measure in a report view—including calculated measures new numeric data that is derived from other measures, functions, and constants, such as profit margin that is calculated from the revenue and cost measures. A user places a mouse cursor over a category in the cross tab display and selects “Actions-insert Calculation from the popup menu”. Clicking “OK” then adds the new column/row to the cross tab.

A query viewed from a report can have a new ‘Create alert’ button accommodated on a toolbar. Clicking this button will start an agent wizard that will prompt for elements such as agent name, agent description, schedule, recipients, and message format. Data sources can be personalized. Filters are provided to remove unwanted elements—such as totals, A rebuild signals a refresh of agent indicating that an update has occurred. The server computer is separate from any mail queues in case of either being down.

Should a user wish to unsubscribe to an agent, they simply reply to the message sent with the word unsubscribe; the system will then read the subject line for the word “unsubscribe”, that when present directs the system to then read the footer code for more details. The existing access control/security system can limit event detection through global filtering to areas such as Europe vs. North America, providing a better way to individualize notifications by user.

Multiple rules per agent are provided as a standard feature in the client and can be achieved by selecting multiple filter conditions in queries. When an agent contains two or more rules, the conditions are “ANDed” together. A user may also create aggregate rules, using either AND or OR operators, making it possible to create agents that detect conditions such as “Europe AND Potatoes” OR “Asia AND Rice”.

The invention can monitor operational events across multiple processes since the architecture enables the “joining together” of disparate systems, and can provide support for managers with responsibilities that cross several processes. The invention enables agents to be defined in a manner that enables them to cross multiple systems.

The system minimizes the amount and increases the quality of events detected. As well, the system is processor efficient, avoiding “brute force” methods that require large overhead. The invention filters events to see only useful information, empowering users by maximizing the opportunities and minimizing the risks.

Although the present invention has been described in considerable detail with reference to certain preferred embodiments thereof, other versions are possible. Therefore, the spirit and scope of the appended claims should not be limited to the description of the preferred embodiments contained herein.

What is claimed is:

1. A trend detection method, for use in an event management system, comprising the steps of:
(i) storing event data from a plurality of events in an event store;
(ii) subsequently analyzing said stored event data, and
(iii) determining one or more trends from said analysis.

2. The method according to claim 1, further comprising the step of updating said event management system based on a determined trend.

3. A trend detection system, for use in an event management system, comprising:
an event data store for storing event data from a plurality of events;
an analyzer for subsequently analyzing said stored event data, and
a trend determiner for determining one or more trends from said analysis.

4. The system according to claim 3, wherein said event management system has access to at least one data source and includes:
a server component having:
an agent engine for creating one or more agents; and
a scheduler for running said created agents;
a definition data store for storing data definitions;
a client component for authoring said agents using said definitions; and
an interface between said agent engine and said data source.

5. The system according to claim 4, wherein two or more data sources are pooled to improve system efficiency.

6. A trend detection system, for use in an event management system, comprising:
means for storing event data from a plurality of events in an event store;
means for subsequently analyzing said stored event data, and
means for determining one or more trends from said analysis.

7. A storage medium readable by a computer encoding a computer process to provide a method for trend detection method, for use in an event management system, the computer process comprising:
a processing portion for storing event data from a plurality of events in an event store;
a processing portion for subsequently analyzing said stored event data, and
a processing portion for determining one or more trends from said analysis.
